(19) United States
(12) Patent Application Publication
(10) Pub. No.: US 2004/0039748 A1
(43) Pub. Date: Feb. 26, 2004

(54) Systems and methods for implementing database independent applications

(75) Inventors: William A. Jordan II, Westminster, CO (US); Martin L. Vanha, Nederland, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NETdelivery Corporation, Boulder, CO (US)

(21) Appl. No.: 10/226,547

(22) Filed: Aug. 23, 2002

(51) Int. Cl. G06F 17/00; G06F 7/00

(52) U.S. Cl. 707/101

(57) ABSTRACT

Systems and methods for supporting independent data defining layers. In some instaces, such data defining layers are databases. Some of the methods include providing a database including a schema. The schema is analyzed to identify a table on the database. The table is retrieved and formatted as types known to an alternative database and/or an application. Some of the systems include a computer readable medium comprising computer instructions. The computer instructions are executable to access a database and a schema associated therewith. The instructions are further executable to analyze the schema and format data associated with the database as a format known to an alternative database and/or an application.

### CROSS REFERENCE TO RELATED APPLICATIONS

The present invention is related to U.S. patent application Ser. No. ______, entitled SYSTEMS AND METHODS FOR IMPLEMENTING EXTENSIBLE GENERIC APPLICATIONS (Attorney Docket Number 019555-005300US); and U.S. patent application Ser. No. ______, entitled SYSTEMS AND METHODS FOR STORING DIFFERING DATA FORMATS IN FIXED FIELD DEFINITIONS (Attorney Docket No. 019555-005100US) all of which are incorporated herein by reference for all purposes and filed on a date even herewith.

### BACKGROUND OF THE INVENTION

This invention relates generally to accessing and modifying databases and elements maintained thereon. More particularly, this invention relates to creating database independent applications that are capable of use with a variety of government regulatory schemes. Additionally, the invention relates to modifying data to provide independence from particular database platforms.

In a typical scenario, a company desiring to maintain records related to various activities of the company, develops a database of records and applications to access, utilize and modify the records. These applications are developed for use with a particular database. Thus, for example, where a company chooses an SQL server database, the applications are developed using SQL calls to access the database.

This is problematic for the company that later decides to change from an SQL server database to another type of database, such as, for example, an Oracle database. Such a change generally requires significant duplication in effort to assure previously developed applications will work in relation to the newly chosen database.

Furthermore, the current state of database operation limits use of such databases in relation to international development of particular company. As one example, where a company expands from the United States to, for instance, Sweden and will thus maintain part of a database in the United States and part of the database in Sweden, the company is required to conform to regulatory requirements of both Sweden and the United States. As a hypothetical example, where Sweden requires that an individual's identification number be encrypted and the United States requires that an individual's bank account number be encrypted, either both fields must be encrypted, or separate databases, and applications associated therewith, must be maintained for each country. Neither of these solutions is desirable as they result in over encryption and/or inefficiencies.

Further, adding elements to a database can cause additional problems in the environment as it currently exists. For example, an application that requests all elements from a database will receive either more or less than expected if the elements of the database are modified. Receiving information apart from that expected often has deleterious effects upon the proper function of an application. Thus, in the current database environment, it is often necessary to test, or even re-write applications when elements are either added or deleted from a particular database. This is not desirable as it limits the ability to grow a database with the needs of a particular user or company.

Thus, there is a need for systems and methods that will allow an independent database to grow and change with the needs of the company without requiring regeneration of associated applications. This and other advantages are provided by the present invention.

### BRIEF SUMMARY OF THE INVENTION

The present invention provides systems and methods for developing and maintaining data layer independence. Furthermore, the invention provides systems and methods for converting between a variety of data defining layers. In some embodiments, such conversion is accomplished without requiring modification to applications accessing the databases. Various embodiments of the invention provide systems and methods for complying with government regulatory schemes including, but not limited to, maintaining various data elements in an encrypted format that is transparent to a calling application.

One method according to the present invention includes providing a first data defining layer with an associated schema. The schema is analyzed to identify one or more invokable methods that are accessible via the first data defining layer. In some instances, the first data defining layer can be a first database, and the invokable methods can include tables with one or more elements of a data type known to the first database. For example, where the first database is an SQL server database, elements on the first database would be types related to an SQL server database. The table is formatted by modifying the type or types associated with the one or more elements to types known to a second database and/or application. Thus, data associated with the first database is cast to conform to alternative databases and applications.

In various embodiments, the methods include physical storage of data from the first database to the second database. Further, some embodiments can include creating a second schema for the alternative database. The second schema is created in a format known to the second database. Thus, for example, where the second database is an ORACLE server database, the second schema is created in a format consistent with an ORACLE server database.

In other embodiments, the methods include creating a data interface layer that provides access to data on the first database via a format known to an application. In some embodiments, the data interface layer comprises a schema for the first database in a form known to the application. In yet other embodiments, the data interface layer further comprises one or more commands associated with data on the first database. The commands can be a read command, a create command, an update command, a terminate command, and/or a delete command.

In some embodiments of the present invention, one or more elements associated with the first database are encrypted. This provides functionality allowing compliance with various government regulatory schemes. In various embodiments, data is accessed from a first database, encrypted, and stored to an alternative database. Alternatively, some embodiments include accessing data from the first database that is maintained in encrypted form, decrypting the data, and storing the data to an alternative database in the decrypted form. In some embodiments, a data interface layer is created that includes commands for encrypting and/or decrypting various data elements. Thus, by accessing the data via the data interface layer, such encryption and/or decryption can be made transparent to an application.

Other embodiments of the present invention include systems for supporting independent data defining layer implementation. The systems include a computer readable medium comprising computer instructions. The computer instructions are executable to access a first data defining layer and a schema associated therewith. The instructions are further executable to analyze the schema and identify invokable methods accessible on the first data defining layer. The invokable methods include one or more elements of a data type known to the first data defining layer. The instructions are also executable to format the table as types known to a second data defining layer and/or an application.

This summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a illustrates system components including a database configured in accordance with an embodiment of the present invention;

FIGS. 1b and 1c illustrate a logical configuration of the database of FIG. 1a in accordance with one embodiment of the present invention;

FIG. 2a illustrates an application in communication with a database in accordance with an embodiment of the present invention;

FIG. 2b illustrates a schema associated with the database of FIG. 2a;

FIG. 2c provides detail of a data interface layer in accordance with an embodiment of the present invention;

FIG. 2d illustrates a process in accordance with an embodiment of the present invention for converting a data defining layer into an alternate data defining layer with modifications introduced via a rule set;

FIGS. 3a and 3b illustrate flow diagrams outlining methods of implementing alternate databases, encrypting various data fields, and generating data interface layers in accordance with various embodiments of the present invention; and

FIGS. 4a-4d illustrate different schema known to a variety of databases and applications in accordance with embodiments of the present invention.

### DETAILED DESCRIPTION OF THE INVENTION

The present invention provides systems and methods for allowing an independent implementation of a data defining layer that can grow and change as data needs change. Such growth can be accomplished without requiring regeneration of applications used in relation to a particular data defining layer. More particularly, the invention provides systems and methods for conversion between various data defining layers, for creating a data interface layer to insulate a group of applications from any particular data defining layer, and for providing a location or user specific implementation of a data defining layer. These and other inventions are disclosed in the following detailed description.

For purposes of this document, a data defining layer can be anything that defines and/or provides structure to data. Thus, for example, a data defining layer can be a database, an implicit ordering in a text file, a dictionary or telephone book structure, or the like. Further, as used herein, an invokable method can be any procedure that once invoked performs a predetermined function. For example, an invokable procedure can be an SQL stored procedure, such as, create, read, update, terminate, or other such procedure. As yet other examples, such invokable methods can include stored procedures on other database types, event triggers, indexes, tables, constraints, data types, relational files, or the like.

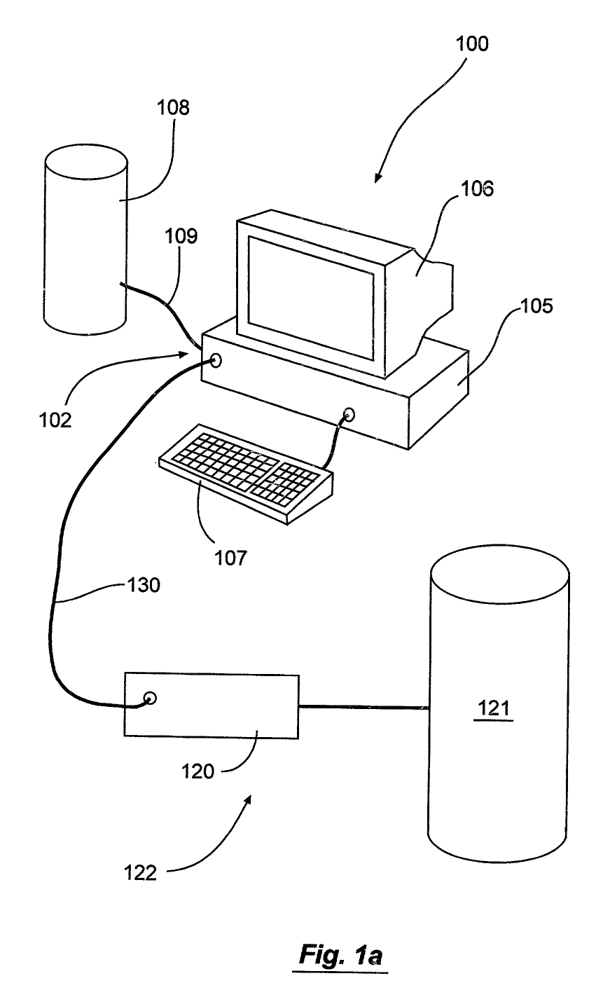

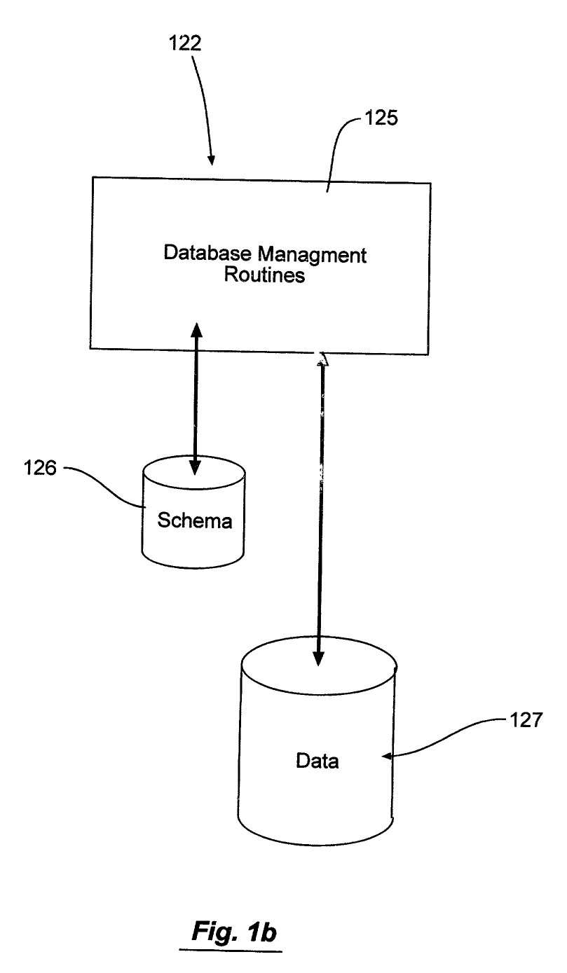

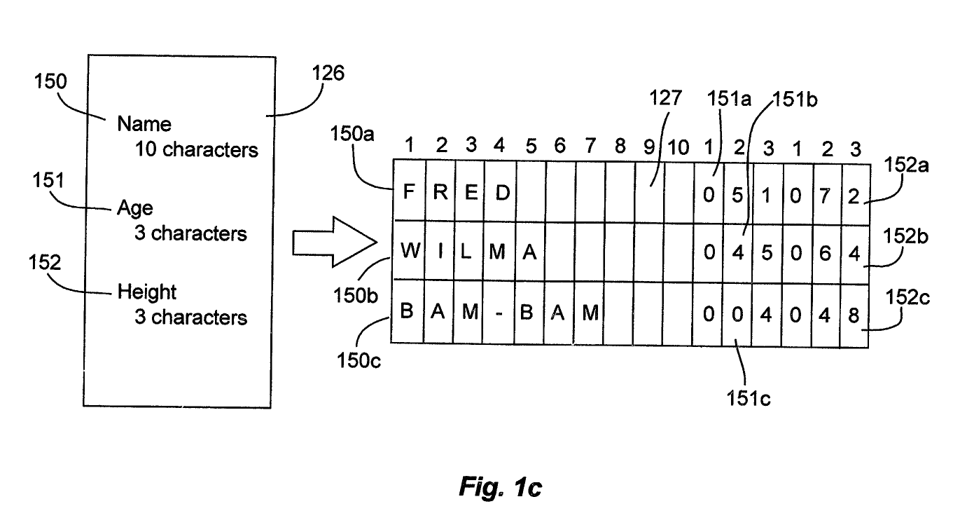

FIGS. 1a-1c illustrate elements associated with a system 100 in accordance with one embodiment of the present invention. Referring to FIG. 1a, system 100 comprises a computer 102, a computer readable medium 108, and a database 122. Computer 102 includes a microprocessor based processing unit 105, an I/O device 107, and a display 106. It should be recognized that computer 102 can be any microprocessor based device, including, but not limited to, a personal computer (“PC”), a database server, a network server, a personal digital assistant (“PDA”), an intelligent cellular telephone, and/or a cellular telephone with integrated PDA. Furthermore, it should be recognized that in some embodiments, computer 102 may not include display 106 and/or I/O device 107 and that any type or combination of displays and/or I/O devices are possible in accordance with the present invention.

Computer readable medium 108 can be any device or system capable of maintaining data in a form accessible to computer 102. For example, computer readable medium 108 can be a hard disk drive either integral to processing unit 105 or external to processing unit 105 and attached by a cable 109. Alternatively, computer readable medium 108 can be a floppy disk or a CD-ROM apart from processing unit 105 and accessible by inserting into a drive (not shown) of processing unit 105. In yet other alternatives, computer readable medium 108 can be a RAM integral to processing unit 105 and/or a microprocessor (not shown) within processing unit 105. One of ordinary skill in the art will recognize many other possibilities for implementing computer readable medium 108. For example, computer readable medium 108 can be a combination of the aforementioned alternatives, such as, a combination of a CD-ROM, a hard disk drive and RAM.

In some embodiments, computer readable medium 108 includes computer instructions executable by computer 102 to perform one or more functions. Such computer readable instructions can be software source, object and/or machine code. In some embodiments, the computer readable instructions are compiled from one or more of JAVA, “C”, or “C++” source code. Other embodiments include computer instructions specific to database 122 including, but not limited to, SQL and/or ORACLE database instructions. The preceding provides various examples of computer capabilities and computer instructions, however, it should be recognized that a number of different capabilities and/or computer instructions are possible in accordance with the present invention. For example, computer 102 and computer instructions associated therewith can be capable of accessing data from database 122 via a network 130 or any number of other functions.

Network 130 can be any type of communication connection between the computer 102 and database 122. For example, network 130 can be any network which provides for communication between various computers or nodes, such as, for example, the Internet, a local area network (LAN), a wide area network (WAN), a wired telephone network, a cellular telephone network, a virtual private network (VPN), an optical network, a wireless network, or any other similar communication network. Furthermore, network 130 can comprise a combination of communication networks. For example, network 130 can include a VPN between an interim node (not shown) and computer 102 and the Internet between database 122 and the interim node. In one embodiment, network connection 130 is the Internet.

Database 122 can include a microprocessor based data processing unit 120 and a data storage unit 121. In some embodiments data processing unit 120 is a database server and data storage unit 121 is an array of hard disk drives. In particular embodiments, data processing unit 120 is an SQL server database server, while in other embodiments, it is an ORACLE database server. It should, however, be recognized that any type of database can be used in accordance with the present invention.

Referring to FIG. 1b, a logical diagram of database 122 is presented. Database 122 can include database management routines 125 capable of execution by data processing unit 120, and schema 126 (e.g., locating device) providing information in part reflecting data 127.

For purposes of this document, a database is a system or component comprising a schema and an access mechanism used in relation to storage, manipulation, reporting and/or management of data. The access mechanism is a component or system comprising commands for accessing data and devices for accessing the data. Thus, as an example, an access mechanism can comprise a microprocessor that executes commands for retrieving and storing data on the database.

A schema is a computer readable version of the location and format of data stored on the database that is useful in accessing the data maintained on the database. Such schema provide a model for data stored on the database, while one or more instances of data fitting the model are stored on the database. Thus, referring to FIG. 1c, an example of schema 126 and data 127 is illustrated. More specifically, schema 126 describes the location of data associated with the attributes of one or more people. The attributes include a persons name 150 comprised of ten characters, age 151 comprised of 3 characters, and height 152 comprised of three characters. Three instances (e.g., Fred, Wilma, and Bam-Bam), or in this case different persons, are stored as data 127 consistent with schema 126. The first instance, Fred, is represented by data 150a, 151a, and 152a . The second and third instances, Wilma and Bam-Bam, are represented by data 150b, 151b, 152b and 150c, 151c, 152c, respectively. Embodiments of schema in accordance with the present invention can be of any form including, but not limited to a hierarchical form. Further, a schema may comprise multiple underlying schema in some organized fashion.

Often the schema reflects one or more tables where the elements define the column of the table and the instances define a row of the table. Thus, for purposes of this document, a table is a data space (e.g., in some instances an area of memory storage) defined by elements and instances. A table need not be arranged as rows and columns, however considering it as rows and columns sometimes simplifies both description and analysis. For this reason, tables discussed herein are discussed in terms of rows and columns. However, it should be understood that such descriptions of tables are merely illustrative and not in any way limiting. In addition, it should be recognized that tables can be defined by any number of elements and instances.

Elements within a table can be any type of data. Often elements are associated with other elements within a table, thus, for example, a table may consist of information relevant to a particular person and each of the elements describe a particular aspect of the person. However, it should be recognized that elements within a table may or may not bare some form of relationship.

Elements are of a particular data type. For example, an element may be a sixteen-bit integer or a string of characters. Such types can be specific to a particular database and/or application. For example, an element within an SQL server database may be of the type SQL_TYPE1, while the same element within an ORACLE database is of the type ORACLE_TYPE2. The SQL_TYPE1 would be known to an SQL server database, while the other would be known to an ORACLE database. Such types define the amount of memory space required to maintain the element as well as attributes of the element, including but not limited to, whether the element is signed or unsigned, or encrypted or decrypted.

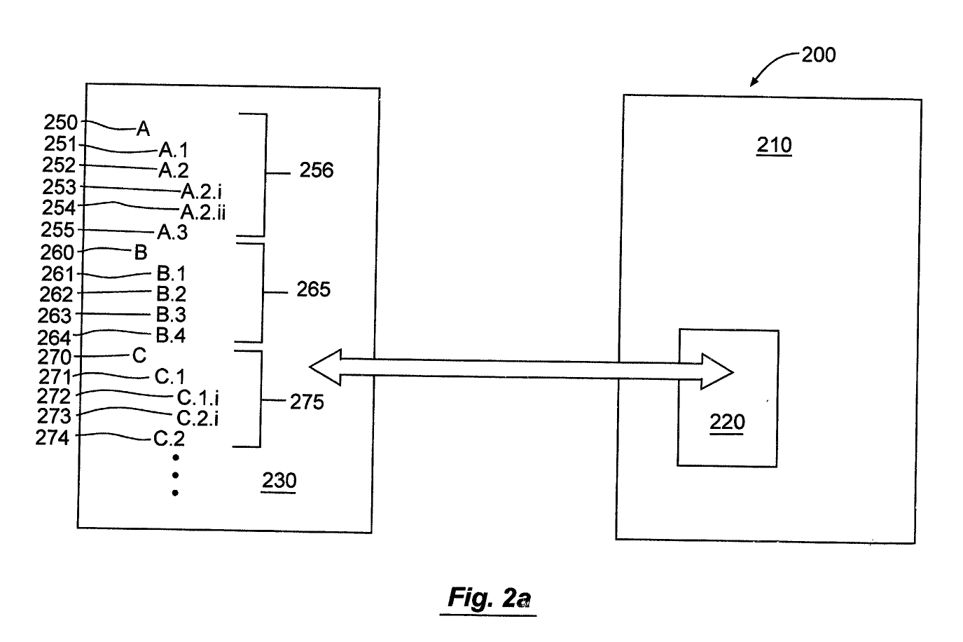

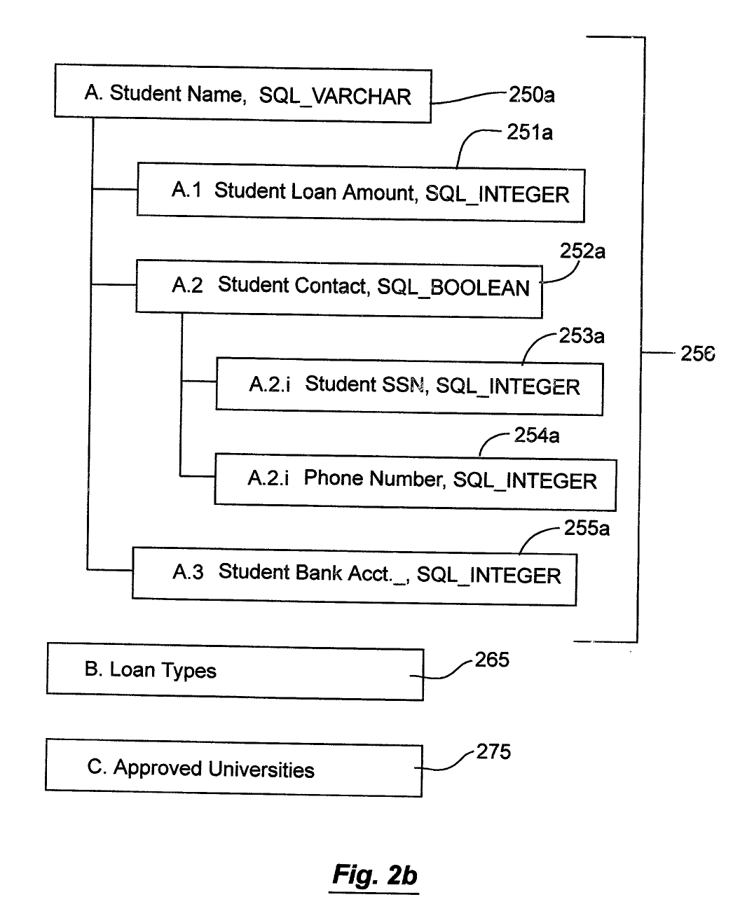

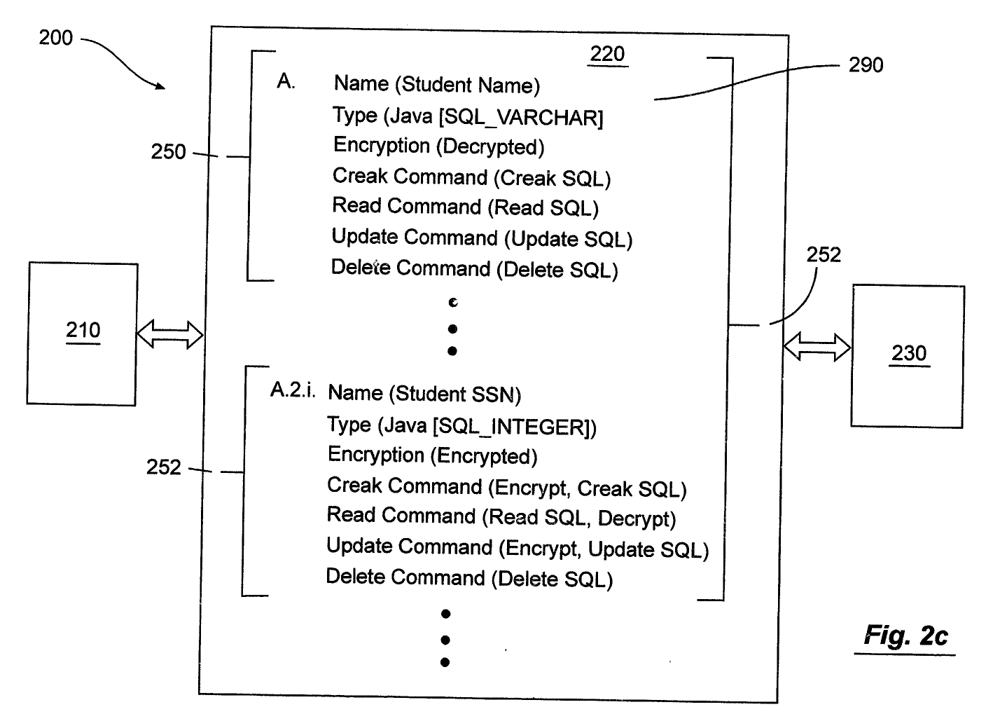

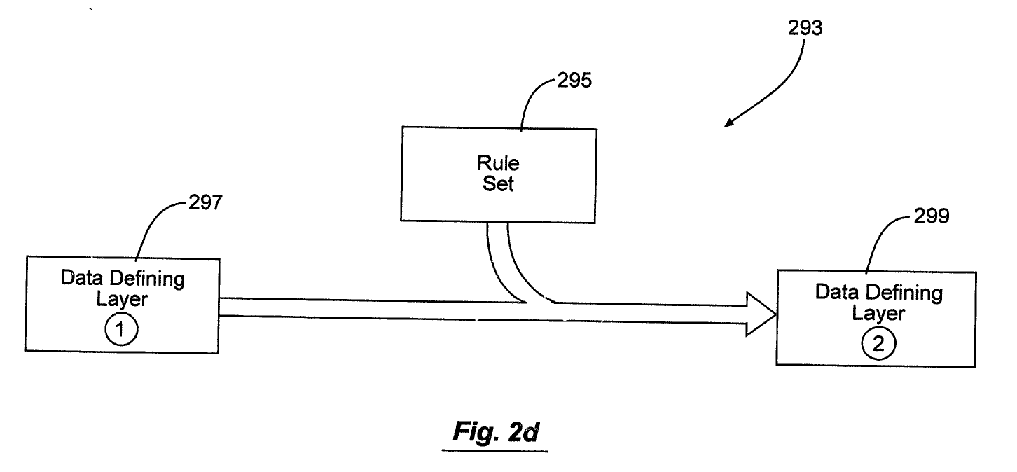

FIG. 2a provides a block diagram 200 illustrating an application 210 including a data interface layer 220 in accordance with an embodiment of the present invention. Application 210 is capable of accessing a database 230 including a schema comprised of a table A 256, a table B 265 and a table C 275. Table A 256 comprises various elements 250, 251, 252, 253, 254, 255. Table B 265 and table C 275 comprise elements 260, 261, 262, 263, 264 and elements 270, 271, 272, 273, 274, respectively.

In some embodiments, application 210 can be a computer software application that provides for accessing and manipulating database 230. For example, application 210 can be an electronic telephone directory that allows a user to look up the telephone number for a particular person. As another example, application 210 can be the same electronic telephone directory that additionally provides a user with the ability to input or modify information maintained on database 230. In some embodiments, application 210 is written in JAVA, while in other embodiments, application 210 is written in C or C++. As discussed below, data interface layer 220 provides an interface through which application 210 can access database 230.

Referring to FIG. 2b, table A 256 on database 230 is described for an embodiment where database 230 is an SQL server database. In the embodiment, table A 256 includes element 250a providing a student name in a field of the SQL type SQL_VARCHAR. Element 251a provides the amount of student loans outstanding for the student in a field of the SQL type SQL_INTEGER. Element 252a provides an indication of whether the student has been contacted about the loans in a field of the SQL type SQL_BOOLEAN. Element 253a provides the student's social security identification number in a field of the SQL type SQL_INTEGER. In this embodiment, Element 253a is maintained in encrypted form on database 230 as indicated by the schema associated with database 230. Element 254a provides the student's telephone number in a field of the SQL type SQL_INTEGER. Element 255a provides the student's bank account number in a field of the SQL type SQL_INTEGER. It should be recognized that tables B and C 265, 275 can be of similar format to that described in relation to table A 256.

Further, it should be recognized that database 230 can be any type of database including, but not limited to, an ORACLE database. Thus, in the case where database 230 is an ORACLE database, the element types would be types known to an ORACLE database, such as, for example, ORACLE_INTEGER.

As more fully described below, FIG. 2d illustrates a process 293 in accordance with embodiments of the present invention, whereby a first data defining layer 297 is transformed into a second data defining layer 299. As process 293 proceeds, a rule set 295 is applied to implement various other modifications in the second data defining layer 299. Thus, for example, element 250a can be defined as an ORACLE_VARCHAR type in second data defining layer 299, whereas the same element is defined as an SQL_VARCHAR in first data defining layer 297. This is accomplished as part of converting from one schema to another. Further, element 250a can be indicated as encrypted by second data defining layer 299, and unencrypted on first data defining layer 297. This is accomplished by implementing one or more rules within rule set 295 that control the modification of elements from one data defining layer to another.

Referring to FIG. 2c, an embodiment of data interface layer 220 is illustrated in relation to application 210 and database 230. As previously mentioned, data interface layer 220 provides an interface whereby application 210 can access data to/from database 230. Data interface layer 220 can be written in a software language, such as JAVA, C and/or C++. In some embodiments, data interface layer 220 is compiled with application 210, while in other embodiments, it is developed and compiled apart from application 210.

Referring to FIG. 2c, an exemplary embodiment of data interface layer 220 is illustrated for the instance where application 210 is a JAVA application and where database 230 is an SQL server database. To allow access to database 230 in a manner that isolates application 210 from database 230, data interface layer 220 includes a schema 290 of relevant tables accessible on database 230. While providing an outline of data available on database 230, schema 290 is provided in a form known to application 210. Thus, for example, where application 210 is a JAVA application, schema 290 can be in the form of a consistent set of JAVA classes that a developer can use to interface with database 230. Such JAVA classes can be constructed of JAVA objects built to handle desired access procedures for database 230. Portions of schema 290 describing elements of table A 256 is illustrated. More specifically, schema 290 includes a description of elements 250 and 252 of table A 256.

Element 250 is called “NAME” and is of a type known to application 210. Thus, in this embodiment where application 210 is a JAVA application, NAME is of a JAVA type. The JAVA type selected to define NAME is chosen for its compatibility with the type (e.g., SQL_INTEGER) that element 250 is maintained as on database 230. Thus, for example, where the student names are maintained as a type SQL_VARCHAR on database 230, the JAVA type for NAME will be a type compatible with SQL_VARCHAR. Where SQL_VARCHAR is a 128-bit unsigned field a JAVA type representing a 128-bit unsigned field is chosen. Alternatively, where the element is to be maintained in an encrypted format on the database, a field of sufficient size to maintain the encrypted 128-bit data is chosen. Altematively, where the element is to be maintained in a compressed format, a field of sufficient size to maintain the compressed 128-bit data is chosen. By providing such typing of database elements, data interface layer 220 is capable of allowing data to be accessed on database 230 without application 210 being cognizant of the data types specific to database 230.

In addition, such typing allows for type checking in various embodiments of data interface layer 220. Thus, as an example, where application 210 attempts to write a 256-bit number as element 250, data interface layer 290 can provide an error indicating a failure based on the incompatibility of the data provided by the application to the field maintained on database 230.

This data checking capability can be exploited to reduce development time and/or runtime errors. More particularly, an error can be flagged when application 210 is compiled where the data types used by application 210 are incompatible with data types defined in data interface layer 220. This allows an application to be thoroughly debugged prior to any actual access to database 230. Because of this, the incidence of failure due to incompatibility between database 230 and application 210 can be reduced and/or resolved prior to deploying a newly developed or newly modified application.

In addition to functionality related to data types, data interface layer 220 can include access commands tailored to a specific data element and/or table. Such commands can include encryption and decryption commands, creation commands, read commands, update commands, and delete commands. In some embodiments, the commands are written as objects accessible by application 210 and provide functionality of access commands specific to database 230. Thus, for example, where database 230 is an SQL server database, a create command provided in data interface layer 220 would provide one or more SQL specific commands to access database 230 and create an element 250 thereon.

As just one example, code segment one provides commands that can form part of data interface layer 220. Code segment one is provided on “Computer Program Listing Appendix” included herewith and incorporated herein by reference for all purposes. More particularly, data interface layer 220 can include an activity values class, or a structure that is generated to represent the fields that exist in a table on the database. This class can also encompass some validation that verifies the data provided is the correct data type and also within the proper constraints that are provided by the database. For example, it can be assured that a field is only null when nulls are allowed, that the length of the data is within the length of what the database will support, and the like. As another example, code segment two on the same Computer Program Listing Appendix provides the behavior that can be performed on an activity object. This allows an activity record to be created (e.g., inserted), updated, deleted, and selected. It should be recognized that not all behaviors are represented in the code segment. For example, no terminate command is represented. As yet another example, code segment three on the same Computer Program Listing Appendix provides the SQL files that are generated by a system in accordance with the present invention for implementing the create, read, update, and delete behavior as previously described.

In addition, or alternatively, other commands can also be provided as part of data interface layer 220, including but not limited to, read, update and delete. A read command can be provided including one or more SQL specific commands to access database 230, retrieve a particular element therefrom, and provide the retrieved element to application 210. An update command can include SQL specific commands to update a particular element on database 230 and a delete command can include SQL specific commands to delete a particular element from data base 230. Of course, it should be recognized that where database 230 is, for example, an ORACLE database, the commands could include ORACLE specific commands for implementing the desired function.

Other commands can be implemented without using commands that are specific to a particular database, but that are specific to particular data elements maintained on the database. For example, data interface layer 220 can include commands for changing all capital letters to lower case letters. This can be done without any commands specific to database 230. This ability for data interface layer 220 to provide procedures for use in relation to data elements and/or tables allows data interface layer 220 to be used in relation to encrypting or decrypting elements maintained on database 230. As an illustration, element 252 is maintained as encrypted data in some embodiments. Such encryption can be indicated by a field incorporated in data interface layer 220 that indicates that the element is encrypted (e.g., as illustrated in element 252) or decrypted (e.g., as illustrated in element 250).

Where an element is maintained in an encrypted format on database 230, all commands (e.g., create, read, and update) can have associated encryption and/or decryption integrated with the command. In such cases, application 210 need not be aware that a particular element is maintained on database 230 in an encrypted format. An encrypted create command can include one or more commands for encrypting data to be stored on database 230 and one or more SQL specific commands to access database 230 and create an element 250, 252 thereon. An encrypted read command can include one or more SQL specific commands to access database 230 and retrieve a particular element therefrom. In addition, one or more commands are provided for decrypting the element retrieved from database 230. An encrypted update command can include one or more commands to encrypt data provided by application 210 and one or more SQL specific commands to update the encrypted data to data base 230.

Alternatively, the encryption and decryption can be provided separately from the various commands. This allows application 210 to actually perform the encryption and/or decryption based on an indication in data interface layer 220 of the encrypted state of a pail icular element on database 230.

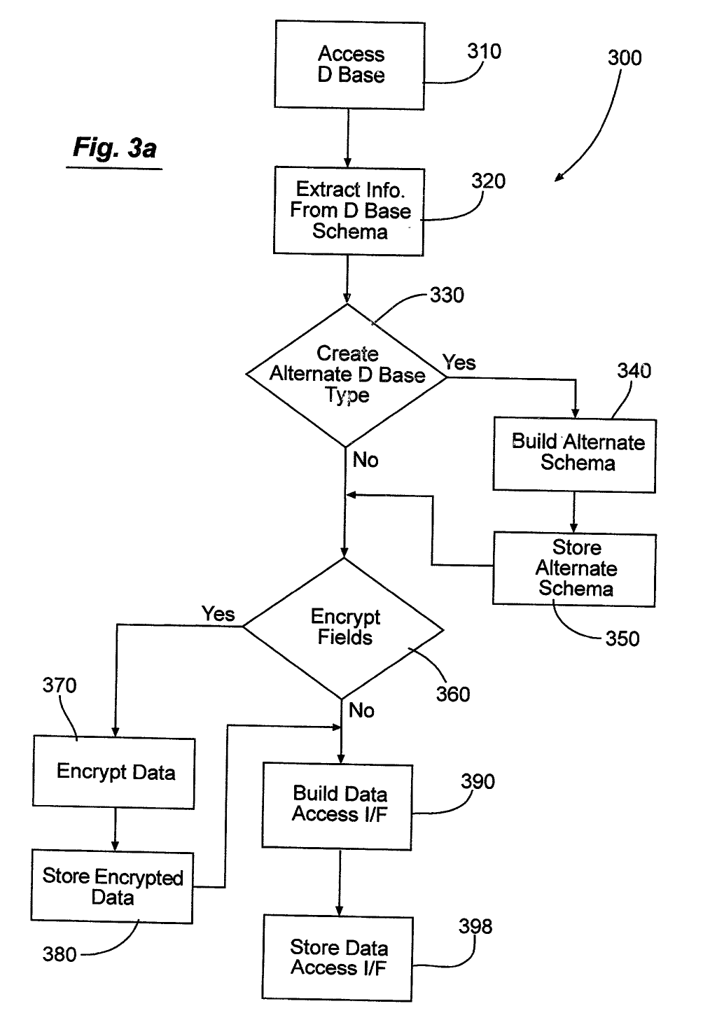

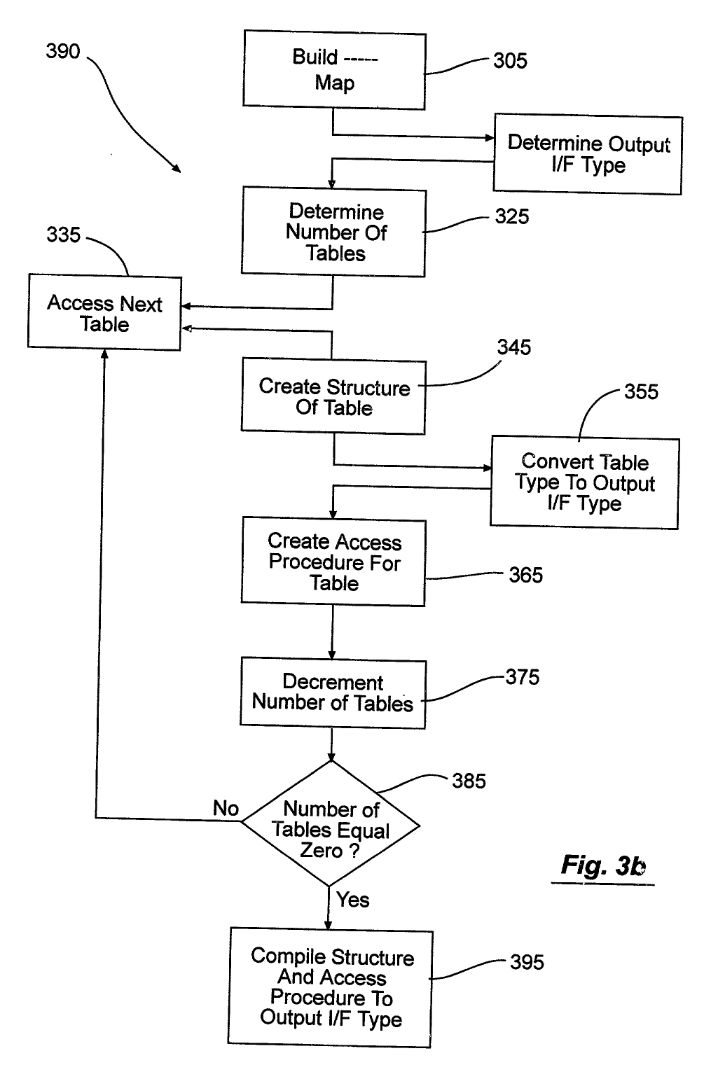

Referring to FIG. 3a, a flow diagram 300 illustrates a method according to an embodiment of the present invention that provides for implementing an alternate database, providing desired encryption/decryption, and for creating a data interface layer. For purposes of illustration, flow diagram 300 is described in relation to elements of FIG. 1. Flow diagram 300 begins by accessing database 122 (block 310). Then, schema 126 is retrieved from database 122 (block 320). Schema 126 information is used to define any implementation of an alternate database or data interface layer.

Next, it is determined if an alternate database is to be implemented (block 330). Thus, for example, where database 122 is an SQL server database, it is determined if an Oracle database is to be implemented with data retrieved from database 122. Where an alternate database is to be implemented, a schema specific to the alternate database is created based on schema 126 (block 340). Creating the alternate schema involves identifying tables and elements from schema 126, and defining tables and elements based on schema 126 that are compatible with the alternate database. Thus, for example, where schema 126 indicates table A 256 as illustrated in FIG. 2b, each of elements 250a, 251a, 252a, 253a, 254a, 255a must be cast as a type compatible with the alternate database. More specifically, where element 250a is a Student Name of a type SQL_VARCHAR which is defined as an unsigned 128-bit field, the element must be defined in a way as to identify a 128-bit unsigned field on the alternate database. In the case where a the alternate database is an ORACLE database, the type could be represented as an ORACLE_VARCHAR that is defined to be a 128-bit unsigned field.

In some embodiments, this is repeated for each table and element maintained on database 122. In other embodiments where an alternate database is intended to hold only a subset of database 122, then only portions of schema 126 corresponding to the subset of data to be maintained on the alternate database are used to build the alternate schema.

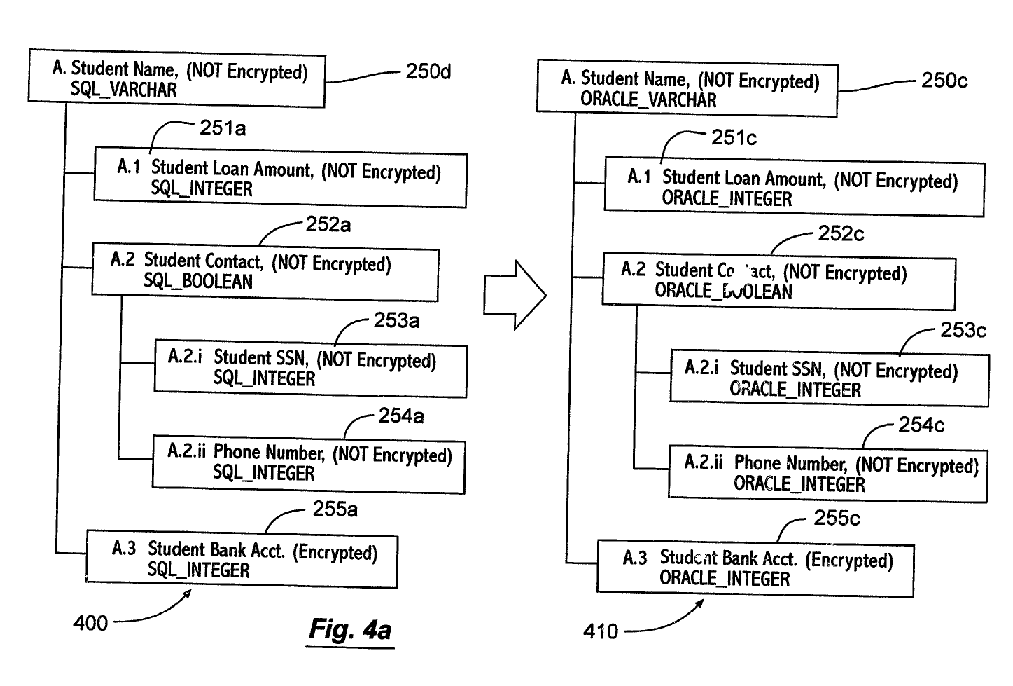

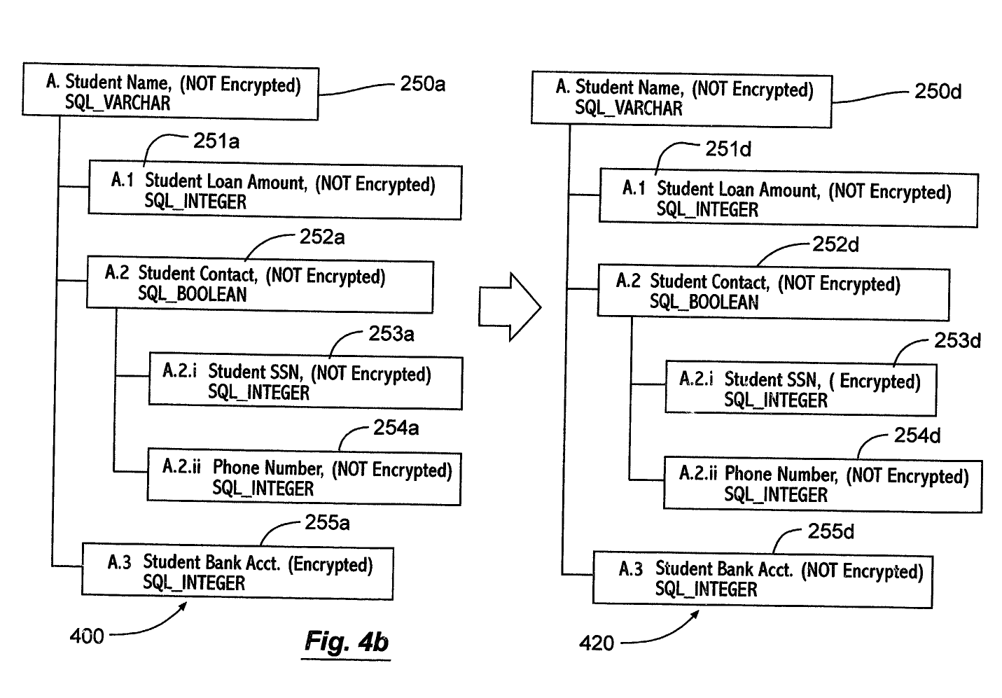

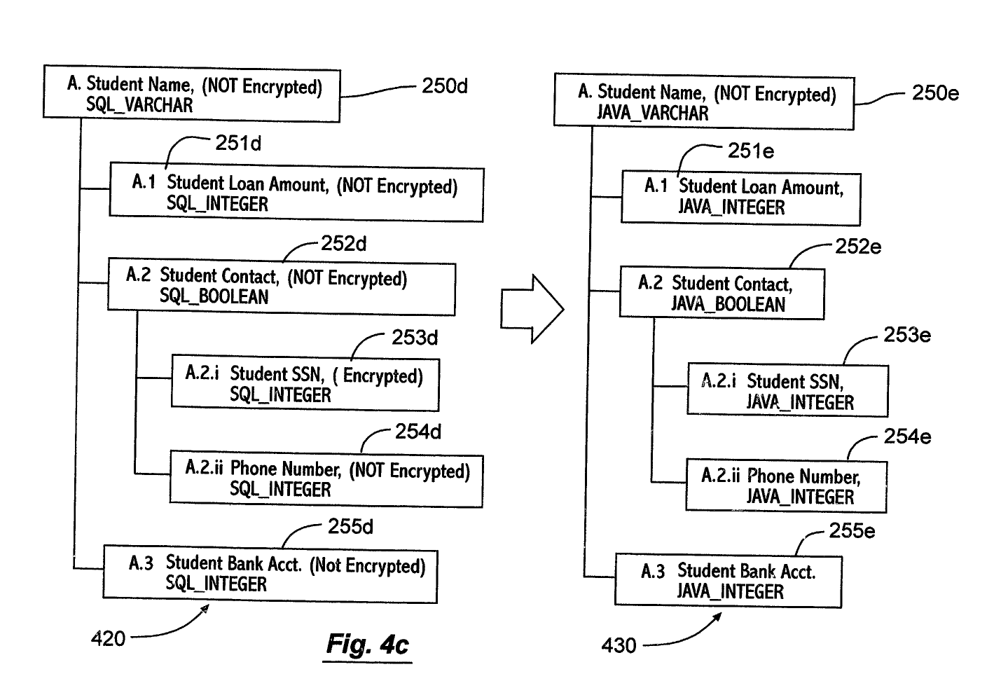

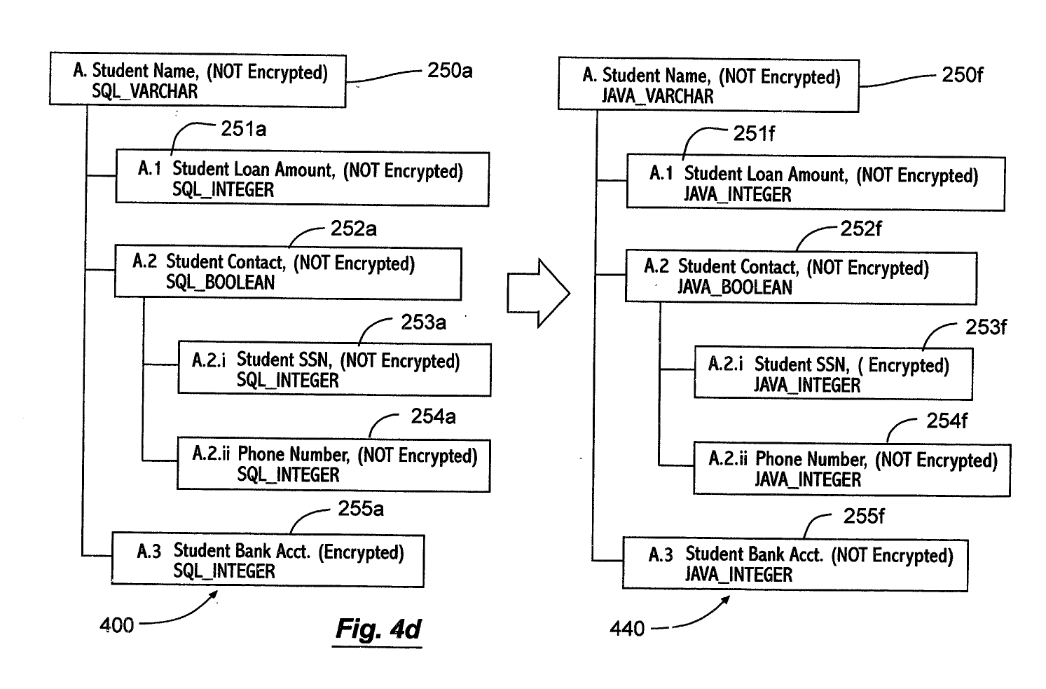

FIG. 4a illustrates such a conversion process where schema 400 (representing a subset of schema 126) is used to build schema 410 in a form known to the alternate database (in this case an ORACLE database). Referring to FIG. 4a, student name element 250a of schema 400 of a type SQL_VARCHAR provides a basis for defining student name element 250c of alternate schema 410. Student name element 250c is defined as a type capable of maintaining an SQL_VARCHAR and known to the alternate database. In this example, where the alternate database is an ORACLE database, the type chosen is ORACLE_VARCHAR. This process is repeated for each of elements 251a, 252a, 253a, 254a, 255a as they are redefined in schema 410 as elements 251c, 252c, 253c, 254c, 255c. Further, the process is repeated for other tables on database 122 as defined by schema 126.

Referring again to FIG. 3a, once the schema for the alternate database is created (block 340) the alternate schema is stored as the schema for the alternate database (block 350). In various embodiments, storing the alternate schema is followed by copying data from database 122 to the alternate database in a form defined by the alternate schema. Further, in some embodiments, a data checking, or validation and verification function is performed to assure that the data retrieved from database 122 is consistent with schema 126 and that upon writing the data retrieved from database 122 to the alternate database, that the data is consistent with the alternate schema.

Once the alternate database is implemented (blocks 340, 350) or if an alternate database was not to be implemented (block 330), it is determined whether any encryption/decryption is to be performed on either database 122 or an alternate database (block 360). For example, where database 122 is to be moved from the United States to Sweden, element 253a that was previously maintained as non-encrypted must be encrypted. In such an example, data associated with element 253a is retrieved from database 122 and encrypted (block 370). The encrypted data is then stored back to database 122 (block 380). In some embodiments, schema 126 is also modified to indicate that element 253a is maintained in an encrypted format and also provide an indication of the type of encryption used.

FIG. 4b illustrates such a conversion process where schema 400 (representing a subset of original schema 126) is used to build schema 420 that is an updated version of original schema 126. Referring to FIG. 4b, student name element 250a of schema 400 is not changed as the encrypted status of the element is not to be changed. This is the same for other elements 251a, 252a, 254a . In contrast, element 253a is retrieved from database 122, converted from a non-encrypted format to an encrypted format, and stored to database 122 in the encrypted format. On the other hand, element 255a is converted from an encrypted format to a non-encrypted format. Upon completion of the desired encryption and/or decryption, schema 420 is used to replace schema 400 as an outline of database 122.

In other embodiments, an alternative database is to be created based on database 122 where elements of database 122 that are maintained in encrypted form are decrypted, while other previously non-encrypted elements are maintained as encrypted elements. For example, it may be desired to create an alternate to database 122 where element 253a is to be maintained in an encrypted format and where previously encrypted element 255a is to be maintained in a decrypted format. In such an embodiment, data associated with element 253a is retrieved from database 122 and encrypted (block 370). The encrypted data is then stored to the alternate database (block 380). Also, data associated with element 255a is retrieved from database 122 and decrypted (block 370). The decrypted data is then stored to the alternate database (block 380). In addition, a schema associated with the alternate database is created and stored on the alternate database. In some embodiments, this alternate schema indicates the encryption or decryption of various tables and/or elements maintained on the alternate database.

After the encryption and/or decryption is completed (blocks 370, 380) or if no encryption or decryption was to be done (block 360) a data interface layer for the newly defined alternate database is built (block 390). The data interface layer is built similar to that described in relation to FIG. 2 and further described in relation to FIG. 3b.

Referring to FIG. 3b, one embodiment of block 390 for building data interface layer 220 is described. In the embodiment, a map of the database to which data interface layer 220 will apply is built using the schema related to the database (block 305). The map includes a listing of all tables and elements within the database that are to be defined within data interface layer 220. After the map is built (block 305), the type of application for with which data interface layer 220 will be used is determined (block 315). This can be determined by querying a user for the type of application, or automatically by providing a reference to the application that is subsequently queried to determine the application type. Application types include, but are not limited to JAVA, C, C++, ORACLE, and SQL.

After the application type is defined (block 315), the number of tables and/or elements to be accessed in the process of creating data interface layer 220 is determined (block 325). This can be done in a number of ways. For example, the map built in block 305 can be queried to determine the total number of tables and/or elements to be defined. Alternatively, desired elements may be provided by a user and upon comparison of the elements with the map built in block 305, a number of tables and/or elements can be defined. In yet another alternative, a user may provide reference to a particular application that includes a list of tables and/or elements. Comparison of this list of tables and/or elements with the map built in block 305 can be used to define the number of elements to be defined. For illustration, it is assumed that the first option of defining all elements included in the map defined in block 305 is followed.

Using the map built in block 305, the first table is accessed from the schema. A structure is then defined for the accessed table (block 345). Thus, as illustrated in FIG. 4d, table A (part of schema 400) is used to define a modified table A (part of schema 440). In some embodiments, the structure of the modified table is similar to the structure of the underlying table, while in other embodiments, the structures are dissimilar.

After the table structure is defined (block 345), element types within the table are modified to a type known by the application type (as determined in block 315) and consistent with the types indicated by the underlying table (e.g., table A from schema 400) (block 355). As an example, SQL types are modified to JAVA types that are consistent with the underlying SQL type.

After the type modification is complete (block 355), access command and/or encryption commands associated with the table and/or elements within the table are created (block 365). As previously discussed, these commands can include create, read, update and delete commands with or without associated encryption functionality.

After the access commands are created (block 365), the total number of tables to be modified is decremented (block 375). If the number of tables remaining is greater than zero, the next table is accessed (block 335) and blocks 345, 355, 365 and 375 are repeated. If the number of tables remaining is zero, structures for each of the tables modified in the process are combined in a single file, including all access commands and data types (block 395).

Referring to FIG. 4c, an example of creating a data interface layer by developing schema 430 based on schema 420 is described. Such a process includes defining types for each of data elements 250d, 251d, 252d, 253d, 254d, 255d that are known to application 210. For example, where application 210 is a JAVA application, the type for student name, element 250, is defined as a form known to application 210 and capable of properly maintaining an SQL_VARCHAR. In an embodiment, this type is defined as a JAVA_VARCHAR. Further, an encryption/decryption indication is added for each of the elements 250e, 251e, 252e, 253e, 254e, 255e based on whether elements 250d, 251d, 252d, 253d, 254d, 255d are encrypted. In addition, commands associated with accessing, encrypting, decrypting or other functions related to the various elements and/or tables are automatically generated and stored as part of schema 430 in a form known to application 210. Data interface layer 220 is stored for use in relation to various applications (block 398). As previously discussed, data interface layer 220 can be compiled with a particular application, or compiled apart from a particular application with the compiled version used in conjunction with the application.

Referring to FIG. 4d, another example related to flow diagram 300 is described. In the example, each of the steps of performing encryption and/or decryption, and creating a data interface layer are performed in a single step where a schema 400 is used to create a schema 440. In the embodiment, elements 250a, 251a, 252a, 254a are modified from types known to an SQL application to types known to a JAVA application. In addition to the type modification, elements 253a, 254a are modified to maintain the respective elements in a desired encryption state.

Therefore, the present invention provides a process that can integrate into a shops build process to take an existing database schema and generate a new schema. In addition, the process can build a set of JAVA classes that interface with one or more database types. Further, the present invention enables encryption and decryption of select elements and/or tables within a database.

To enable development of a robust and scaleable application that can be deployed in multiple environments, on multiple relational databases, and/or with different encryption for different customers or database locations, the present invention provides for isolating a database from the rest of an application. By isolating the database from the application, an application can be developed on one platform (e.g., Windows NT with an SQL server database), and deployed and operated on another platform (e.g., UNIX with an ORACLE database).

Embodiments of the present invention can take an SQL or ORACLE database schema and create a consistent set of JAVA classes that developers can use to interface with a particular database, regardless of actual database that a customer is deploying to. In addition, the present invention can be used to generate a set of store procedures (e.g., Create, Read, Update, Delete) to perform all basic access functions in relation to a database for every table maintained on the database. Such store procedures can be wrapped with a consistent JAVA (or other application type) class structure. The present invention can also be used to handle a known result set from a custom or generated store procedures and allow reuse of previously generated store procedures. Such store procedures can be automatically created by a computer software application embodying the present invention.

Further, the present invention provides the ability to enhance various database functions on a table given key columns in a table. For example, the present invention can provide the ability to terminate a record on a database without deleting the record, if the element or column “terminationDate” is either in or added to a table. Additionally, the last record of a table can be updated if the element “last update is either in or added to the schema.

Yet further, the present invention provides for any field on a database to be encrypted for a particular customer release and for recreating the schema to reflect the appropriate storage area to maintain the encrypted field. This is a particular advantage where international sales are involved, or where a particular customer has a multinational implementation of its database.

Additionally, the present invention provides for transforming one database type into a second database type. For example, the present invention provides for transforming an SQL server database schema into an ORACLE database schema and for mapping all database types to JAVA or other application types.

Embodiments according to the present invention allow for maintaining an application that can be deployed on different databases, and with customer specified fields encrypted, with no impact to the development environment. Also, where all of the database interface is generated, the database schema can be modified with little impact to the integrity of applications associated with the database. In addition, any impacts to changes in the database can be caught at compile time instead of run time. This is important to maintaining a stable build environment.

Additional disclosure related to the present invention is provided by U.S. patent application Ser. No. ______, entitled SYSTEMS AND METHODS FOR IMPLEMENTING EXTENSIBLE GENERIC APPLICATIONS (Attorney Docket Number 019555-005300US); and U.S. patent application Ser. No. ______, entitled SYSTEMS AND METHODS FOR STORING DIFFERING DATA FORMATS IN FIXED FIELD DEFINITIONS (Attorney Docket No. 019555-005100US) both of which were previously incorporated herein by reference for all purposes.

The invention has now been described in detail for purposes of clarity and understanding. However, it will be appreciated that certain changes and modifications may by practiced within the scope of the appended claims. For example, a process whereby an alternate database is implemented, encryption is performed and a data interface layer is created in a single step can be performed in accordance with the present invention. Additionally, any type of application and or database can be manipulated and/or used in relation to the present invention to implement alternate databases and/or data interface layers. Furthermore, a number of known encryption processes and/or devices can be used to perform the methods and implement systems in accordance with the present invention.

Thus, although the invention is described with reference to specific embodiments and FIGS. thereof, the embodiments and FIGS. are merely illustrative, and not limiting of the invention. Rather, the scope of the invention is to be determined solely by the appended claims.

What is claimed is:

1. A method for supporting independent data layer implementation, the method comprising:
providing a first data defining layer, wherein the first data defining layer comprises a schema;
analyzing the schema to identify an invokable method accessible on the first data defining layer, wherein the invokable method comprises one or more elements of a data type known to the first data defining layer; and
formatting the invokable method, wherein the one or more elements are formatted as a data type known to a second data defining layer while maintaining an application interface layer that provides for a common interface to both the first data defining layer and the second data defining layer.

2. The method of claim 1, wherein the data defining layer is a database

3. The method of claim 1, wherein the invokable method is a table.

4. The method of claim 1, wherein formatting the invokable method comprises formatting the invokable method for the second data defining layer, and wherein the schema is a first schema, the method further comprising:
creating a second schema based in part on the invokable method, wherein the second schema is known to the second data defining layer.

5. The method of claim 4, the method further comprising:
storing data to a database in accordance with the second schema.

6. The method of claim 1, wherein the invokable method is a table, and wherein formatting the table comprises formatting the table for an application, the method further comprising:
creating the application interface layer for the application.

7. The method of claim 6, wherein the first data defining layer is a database, and wherein the application interface layer comprises a schema of the first database in a form known to the application.

8. The method of claim 7, wherein the application interface layer further comprises one or more commands associated with the invokable method and selected from the group consisting of a read command, a create command, a terminate command, an update command, and a delete command.

9. The method of claim 1, wherein the first data defining layer is a first database, the second data defining layer is a second database, the invokable method is a first table, and the schema is a first schema, the method further comprising:
analyzing the first schema to identify a second table accessible on the first database, wherein the second table comprises one or more elements of a data type known to the first database;
formatting the first and the second tables, wherein the elements associated with the first and second tables are formatted as a data type known to the second database;
creating a second schema based in part on the first and second tables, wherein the second schema is known to the second database; and
storing elements associated with the first and second tables to the second database in a format consistent with the second schema.

10. A method for supporting independent database implementation, the method comprising:
providing a first database; wherein the first database comprises a first schema;
analyzing the schema to identify an table accessible on the first database, wherein the table comprises at least one element of a data type known to the first database;
creating a second schema, wherein the at least one element is indicated as a data type known to a second database; and
creating a data structure indicated by the second schema that can maintain data associated with the at least one data element in encrypted form.

11. The method of claim 10, the method further comprising:
storing data associated with the table on the first database to the second database, wherein data associated with the at least on data element is stored in in encrypted form on the second database.

12. The method of claim 10, wherein the at least one element is a first element, and wherein a second element associated with the first database is maintained in encrypted form, the method further comprising:
indicating the first element as an unencrypted element on the second database.

13. The method of claim 10, the method further comprising:
formatting the table for an application, wherein the at least one element is formatted as a data type known to the application; and
creating a data interface layer between the application and the database.

14. The method of claim 13, wherein the data interface layer comprises a schema of the first database in a form known to the application.

15. The method of claim 13, wherein the data interface layer comprises a decryption command associated with the table, and an indication of the at least one encrypted element.

16. The method of claim 15, wherein the decryption command is integral to a read command associated with the table.

17. The method of claim 10, wherein another element element is maintained in encrypted form on the second database, the method further comprising:
formatting the table for an application, wherein the other element is formatted as a data type known to the application; and
creating a data interface layer for the application; wherein the data interface layer comprises a decryption command executable to decrypt the other element maintained on the second database in encrypted form.

18. The method of claim 10, wherein the table is a first table and the schema is a first schema, the method further comprising:
analyzing the first schema to identify a second table accessible on the first database, wherein the second table comprises one or more elements of a data type known to the first database;
formatting the first and the second tables, wherein the elements associated with the first and second tables are formatted as a data type known to the second database; and
creating a second schema based in part on the first and second tables and known to the second database; and
storing elements associated with the first and second tables to the second database in a format consistent with the second schema.

19. A system for supporting independent database implementation, the system comprising:
a computer readable medium comprising computer instructions, wherein the computer instructions are executable by a computer to:
access a first database associated with the computer, wherein the first database comprises a schema;
analyze the schema to identify a table accessible on the first database, wherein the table comprises one or more elements of a data type known to the first database; and
format the table, wherein the one or more elements are formatted as a data type known to a second database and/or an application.

20. The method of claim 19, wherein formatting the table comprises formatting the table for the second database and wherein the schema is a first schema, the method further comprising:
creating a second schema based in part on the table, wherein the second schema is known to the second database; and
storing the table to the second database in a format consistent with the second schema.

21. The method of claim 19, wherein formatting the table comprises formatting the table for the application, the method further comprising:
creating a data interface layer for the application; wherein the data interface layer comprises a schema of the first database in a form known to the application.

22. The method of claim 21, wherein at least one of the elements of the table is maintained in encrypted form on the first database and wherein the data interface layer further comprises:
an indication of the encrypted element; and
a command for decrypting the encrypted element.
